(19) United States
(12) Patent Application Publication
(10) Pub. No.: US 2002/0070982 A1
(43) Pub. Date: Jun. 13, 2002

(54) Method and system for presenting digital media

(75) Inventors: Tom C. Hill, Kirkland, WA (US); Robin L. Thompson, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: QBeo Inc.

(21) Appl. No.: 09/923,784

(22) Filed: Aug. 6, 2001

Related U.S. Application Data
(60) Provisional application No. 60/222,851, filed on Aug. 4, 2000.

(51) Int. Cl. G09G 5/00

(52) U.S. Cl. 345/835

(57) ABSTRACT

A user interface method and system is described for presenting digital media to a user in familiar environments, and allowing user manipulation of the media and environments. The digital media includes collections of photographs, which are arranged and presented to the user as photo albums. Each of the photo albums has properties determined by the user, including how a selected photo album will be displayed. Examples include display as photographs in an open photo album, as a collection of framed pictures hanging on a gallery wall, as a storybook with each picture having associated text, and as a filmstrip. Each of the photo albums can also be displayed as a slide show. The user interface also includes menus from which various operations can be selected by the user. User selection of photo albums, individual pictures, and menu options, as well as the entry of text, can be accomplished solely by use of cursor control and selection keys, making the interface particularly well suited to users of set-top box equipped televisions.

### CROSS-REFERENCE TO RELATED APPLICATION

This application claims the benefit of U.S. Provisional Application No. 60/222,851, filed Aug. 4, 2000.

### FIELD OF THE INVENTION

The present invention relates generally to methods and systems for presenting digital media, and more particularly to methods and systems for presenting digital media over the Internet to a person using a personal computer or over a television network to a person using a television equipped with a set-top box.

### BACKGROUND OF THE INVENTION

The advent of personal computers and access to a world-wide network, such as the Internet and World Wide Web, has resulted in individual users having access to a wide variety of digital media. Increasingly, this media is also made available to people using their television equipped with a set-top box. There exist a wide variety of user interfaces for providing access to digital media via the Internet and World Wide Web. However, these interfaces rely on users being fairly sophisticated with computers, computer terminology, and computer operations. Novice computer users and users of televisions equipped with set-top boxes can have difficulty using interfaces requiring a high degree of computer familiarity. In particular, those using set-top boxes usually must rely on conventional television controls, and not the keyboard and mouse typically available with a personal computer.

Accordingly, today's user interfaces for presenting digital media are not readily accessible to novice computer users or users of televisions equipped with set-top boxes. A need exists to further improve the ease-of-use and presentation of digital media, both for the benefit of novice computer users and especially for users of televisions equipped with set-top boxes.

### SUMMARY OF THE INVENTION

In accordance with the present invention, a method and system is disclosed for providing a user interface to digital media, such as photographs. The user interface presents the digital media using graphical representations of real-world environments in which the media is commonly found, such as photo albums, books, film strips, framed works of art on walls, etc. The present invention also discloses a user interface requiring a minimal number of user inputs, such as cursor direction control and selection, for the user to select, edit, and arrange components of the presented digital media.

In accordance with one aspect of the invention, a user interface is provided. The interface presents collections of digital media to a user, with the collections being presented in a format selected by the user and having arrangements and properties determined by the user. The collections of digital media may include photographs, with the collections presented as photo albums. Presentation of the contents of the photo albums can be determined by the user, and can include presentations as an album, as a gallery of pictures, as a storybook having pictures and associated text, as a filmstrip, or as a slide show. Selection of individual photographs within a collection can be accomplished by user actuation of cursor control and selection keys. The interface also includes menus from which operations can be selected by use of the cursor control and selection keys. Such operations allow the user to create, edit, and arrange collections of digital media, to establish associated properties, to input text concerning the media and the user, to view the media, and to purchase products incorporating the media.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram depicting a system component overview in accordance with an embodiment of the present invention.

FIG. 2 depicts an interface screen presented to a user in accordance with an embodiment of the present invention, and depicts collections of photographic digital media as photo albums and user-selectable menu options for managing such media.

FIGS. 3-6 depict alternative embodiments of the presentation of photographs contained in corresponding photo albums shown in FIG. 2.

FIG. 7 is a flow diagram depicting the menu options available to the user presented with the interface of FIG. 2.

FIG. 8 depicts the interface of FIG. 2, with a first of the menu options having been highlighted.

FIG. 9 is a flow diagram depicting a first set of menu operations available to the user upon selection of the menu option highlighted in FIG. 8.

FIG. 10 is a flow diagram depicting a second set of menu operations made available to the user upon selection of a second of the menu options in the interface of FIG. 2.

FIGS. 11 and 12 depict two alternative slide show presentations in accordance with a user selection made from the menu operations of FIG. 10.

FIG. 13 is a flow diagram depicting a third set of menu operations made available to the user upon selection of a third of the menu options in the interface of FIG. 2.

FIG. 14 depicts a menu bar presented to the user of the third set of menu operations of FIG. 13.

FIG. 15 depicts a screen-displayed keyboard presented to the user for entry of textual information.

FIG. 16 is a flow diagram depicting a fourth set of menu operations made available to the user upon selection of a fourth of the menu options in the interface of FIG. 2.

FIGS. 17 and 18 depict photographic enhancement procedures made available to the user of the fourth set of menu operations of FIG. 16.

FIG. 19 is a flow diagram depicting a fifth set of menu operations made available to the user upon selection of a fifth of the menu options in the interface of FIG. 2.

FIGS. 20-22 depict user interface screens presented to the user of the fifth set of menu operations of FIG. 19.

### DETAILED DESCRIPTION OF THE ILLUSTRATIVE EMBODIMENTS

In accordance with embodiments of the present invention, a user interface is provided for presentation of digital media via the Internet and personal computer or via a television network (e.g., cable, satellite, DSL, and other television networks) and set-top box equipped television. In the following description, certain specific details are set forth in order to provide a thorough understanding of various embodiments of the present invention. One skilled in the art will understand, however, that the present invention may be practiced without these details. In other instances, well-known functions, features, and operations have not been shown or described in detail in order to avoid unnecessarily obscuring the description of the various embodiments of the present invention.

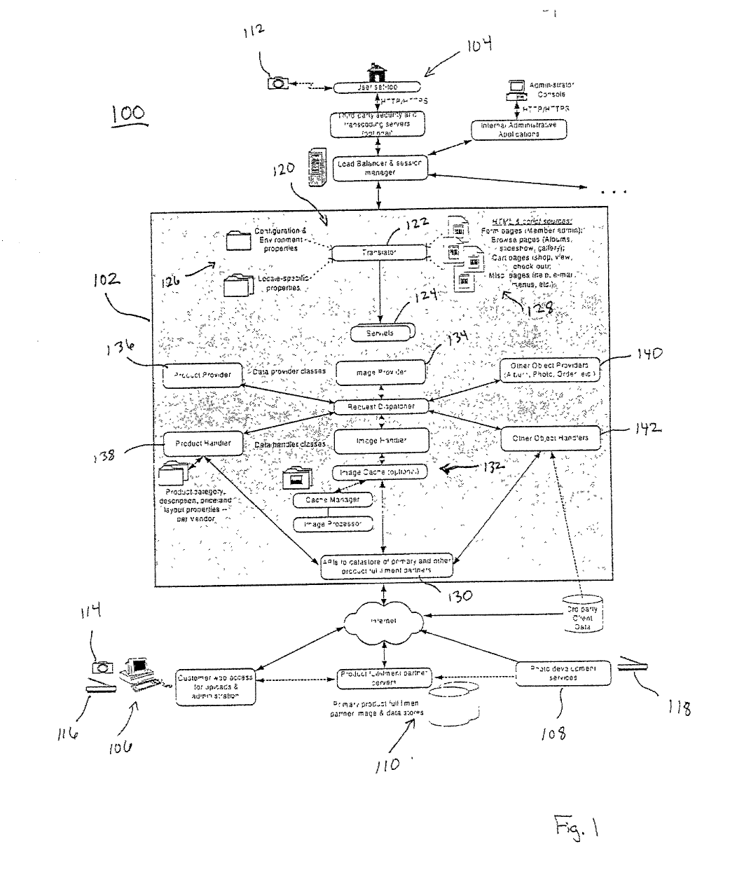

FIG. 1 is a diagram depicting a system 100 in accordance with an embodiment of the present invention. The system 100 includes a server 102 that can be networked to a set-top box equipped television 104 via a cable television operator, or a personal computer 106 via the Internet. The server 102 is also networked with digital media providers, such as photo development services 108, via the Internet. Server 102 is further networked with providers 110 of commercial products for sale to users of the set-top box equipped television 104 or personal computer 106.

Digital media, such as photographic images, may be uploaded to the server 102 either by the users themselves or via the third-party photo development services 108. For example, a set-top box equipped television can be connected to a digital camera 112 or other means of providing digital photographic information, such a scanner. Likewise, a user of the personal computer 106 can provide digital photo information to the server 102 by use of a digital camera 114 or a scanner 116. Similarly, the third-party photo developer 108 can employ a scanner 118 or other source of digital photographic information for provision to the server 102 via the Internet.

As will be understood by those skilled in the art, the server 102 includes an interface 120 to users of the set-top box 104 or personal computer 106, including a translator 122 and servlets 124 for providing the various user interface configuration and environment properties 126 and Web pages or other script sources 128. The server 102 also includes an interface 130 for the commercial product providers 110.

Server 102 also includes digital media handling and management functions 132, such as an image handler, image processor, image cache, and cache manager, as well as an image provider 134 for providing photographic images to the user via the interface 120. Likewise, the server 102 includes product provider and handler functions 136 and 138, and other object provider and handler functions 140 and 142 for handling product requests from users, as well as receiving and relaying product information with the commercial product providers 110. Finally, the server 102 includes a request dispatcher 144 for relaying and translating media or product requests from users of the set-top box 104 or personal computer 106.

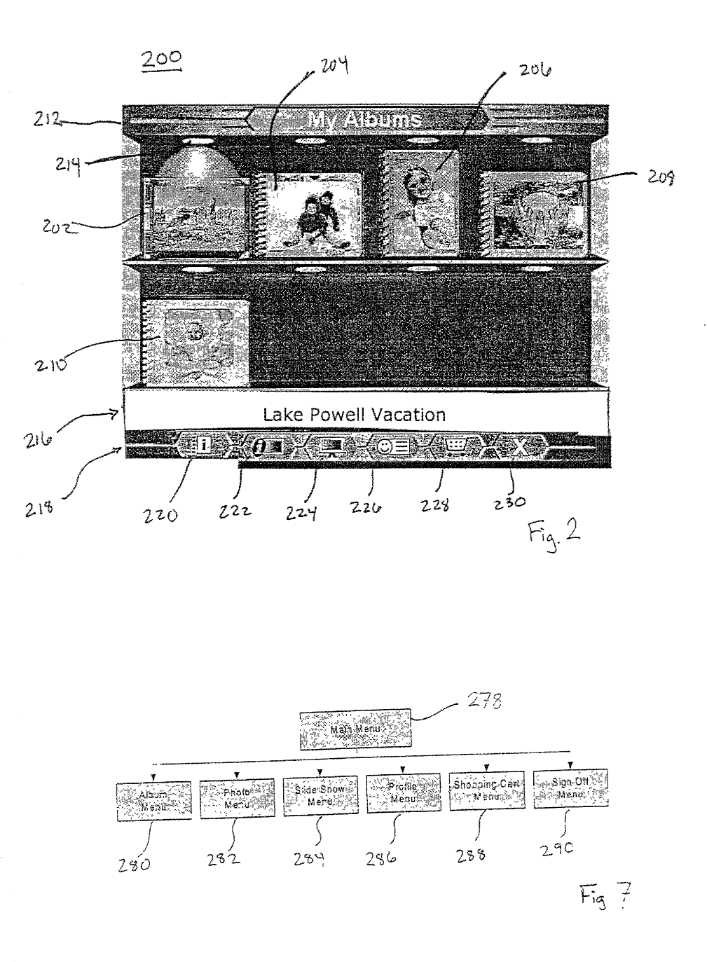

Referring now to FIG. 2, a user interface screen 200 is depicted for displaying digital media, such as photographic media, to a user in a familiar environmental setting. In this case, the user interface 200 depicts collections of digital photographs in the form of a plurality of photo albums 202, 204, 206, 208, and 210 displayed on a bookcase 212. A currently highlighted one of the photo albums (namely, photo album 202) is shown as illuminated by a light 214, and a text region 216 includes a title previously given by the user to the currently highlighted photo album.

The user can choose to highlight a different one of the photo albums by use of the right and left cursor control buttons that are commonly found on a television remote control or keyboard. Alternatively, the user of a personal computer could highlight a photo album by use of the computer keyboard cursor controls or a mouse or other pointing device. Once highlighted, the user can select the photo album for viewing by use of the SELECT (or OK or ENTER or equivalent) buttons commonly found on television remote controls in association with the cursor control buttons. Alternatively, the user of a personal computer could, for example, use the ENTER key on the keyboard or selection button on the mouse.

The interface screen 200 also includes a main menu bar 218 having six menu options depicted as icons—namely, an album menu option 220, a photo menu option 222, a slide show menu option 224, a user profile menu option 226, a shopping cart menu option 228, and an exit or sign off menu option 230. User highlighting and selection of each of these menu display icons 220-230 then allows the user to access sets of operations associated with each of these menus, as will be described in detail below. The user can move between the photo albums 202-210 and the menu bar 218 by use of the up and down cursor control buttons/keys that are commonly found on a television remote control or keyboard. Once the user moves to the menu bar 218, different ones of the menu icons 220-230 can be highlighted by use of the right and left cursor control buttons/keys. Once highlighted, the user can select the corresponding menu option by use of the SELECT button/key (or equivalent). The user of a personal computer could effect similar highlighting and selection functions with a computer keyboard or with a mouse or other pointing device, as well understood by those skilled in the art.

FIGS. 3-6 show different presentations of photographs contained in the photo albums 202-210 in FIG. 2. Each of the photo albums has an associated display presentation that is previously determined by the user when creating the photo album. For example, user selection of photo album 202 results in a gallery display screen 240 shown in FIG. 3, which displays photographs contained within the photo album 202 as framed pictures on a gallery wall. A currently highlighted one of the photographs 242 is shown illuminated by a light 244, with a text region 246 of the gallery display screen 240 containing a title previously given by the user to the highlighted photograph, along with a directional indicator 248 informing the user that additional photographs may be seen.

The menu bar 218 is also displayed in the gallery display screen 240, and the user can choose to highlight and select different ones of the photographs or different menu options by use of the cursor control and SELECT buttons as described above. Selection of a photograph on the gallery display screen 240 can be used to better see the photograph, such as by presenting a full screen image of the photograph.

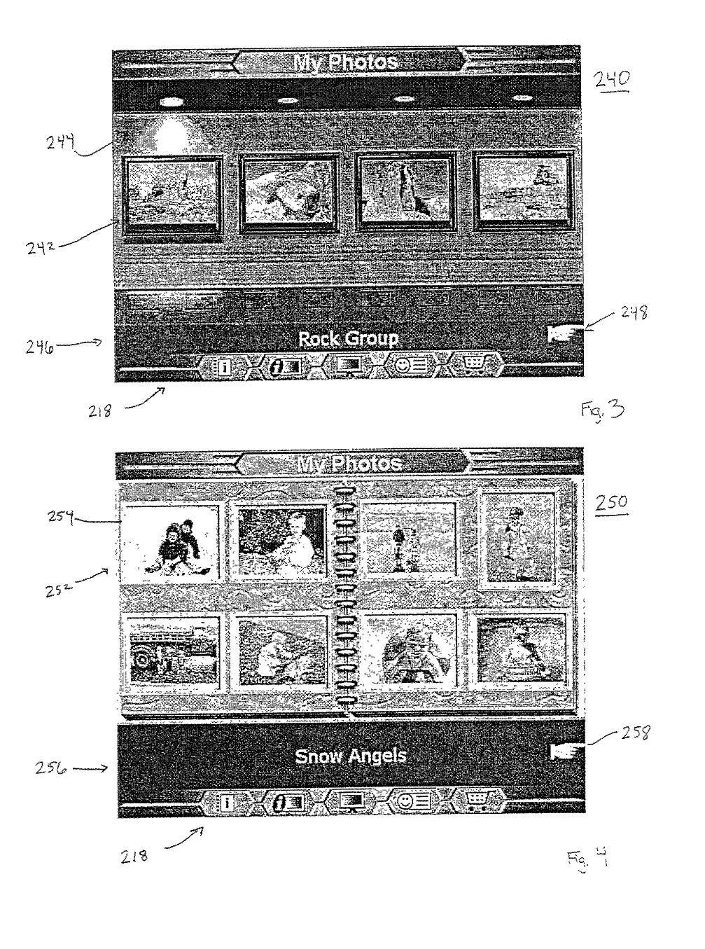

User selection of the photo album 204 in FIG. 2 results in an album display screen 250 shown in FIG. 4, which displays photographs as photos in an open album. A currently highlighted one of the photographs 252 is shown by an illuminated frame 254, with a text region 256 of the album display screen 250 containing a title previously given by the user to the highlighted photograph, along with a directional indicator 258 informing the user that additional album pages of photographs may be seen.

The menu bar 218 is also displayed in the album display screen 250, and the user can choose to highlight and select different ones of the photographs (including turning album pages) or different menu options by use of the cursor control and SELECT buttons as described above. Selection of a photograph on the album display screen 250 can be used to better see the photograph, such as by presenting a full screen image of the photograph.

User selection of the photo album 206 in FIG. 2 results in a storybook display screen 260 shown in FIG. 5, which displays each photograph along with text in a storybook format. A currently displayed photograph 262 is shown along with associated text 264 previously input by the user. A text region 266 of the storybook display screen 260 contains a title previously given by the user to the currently displayed photograph, along with a directional indicators 268 informing the user that other storybook pages may be seen.

The menu bar 218 is also displayed in the storybook display screen 260, and the user can display different photographs and associated text (i.e., turn the storybook pages) or choose to highlight and select different menu options by use of the cursor control buttons as described above. Selection of a photograph on the storybook display screen 260 can be used to better see the photograph, such as by presenting a full screen image of the photograph.

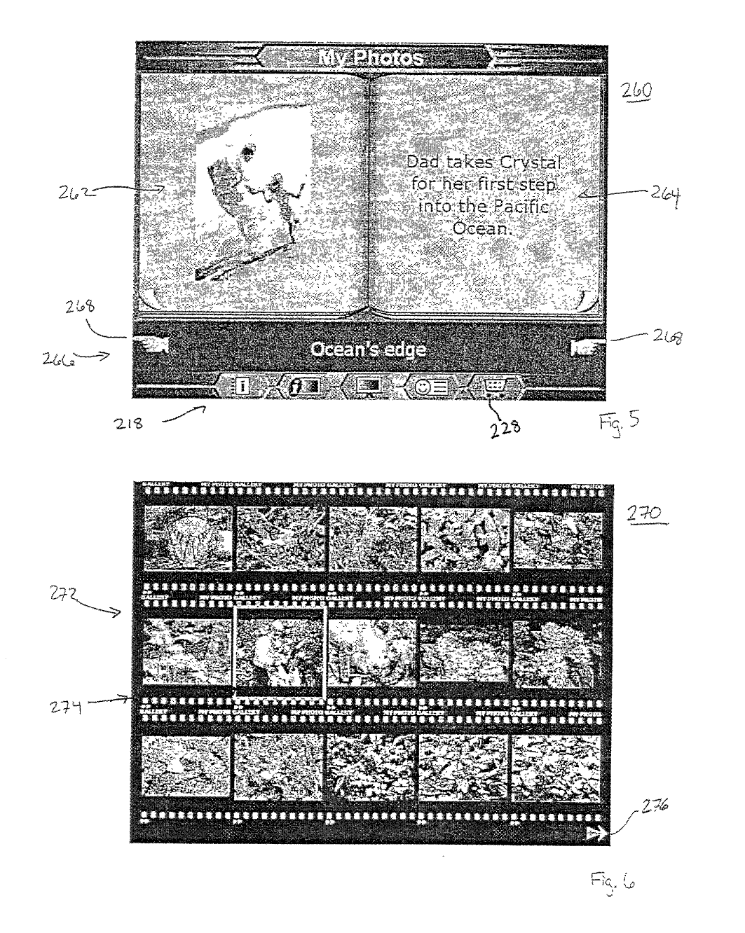

User selection of the photo album 208 in FIG. 2 results in a filmstrip display screen 270 shown in FIG. 6, which displays photographs as images in a filmstrip. A currently highlighted one of the photographs 272 is shown by an illuminated frame 274. A text region (not shown in FIG. 6) may be provided on the album display screen 270 for containing a title previously given by the user to the highlighted photograph. A directional indicator 276 informs the user that additional photographs may be seen.

Although not shown in FIG. 6, the menu bar 218 (see FIGS. 2-5) may also be displayed in the filmstrip display screen 270, and the user can choose to highlight and select different ones of the photographs or different menu options by use of the cursor control and SELECT buttons as described above. Selection of a photograph on the filmstrip display screen 270 can be used to better see the photograph, such as by presenting a full screen image of the photograph.

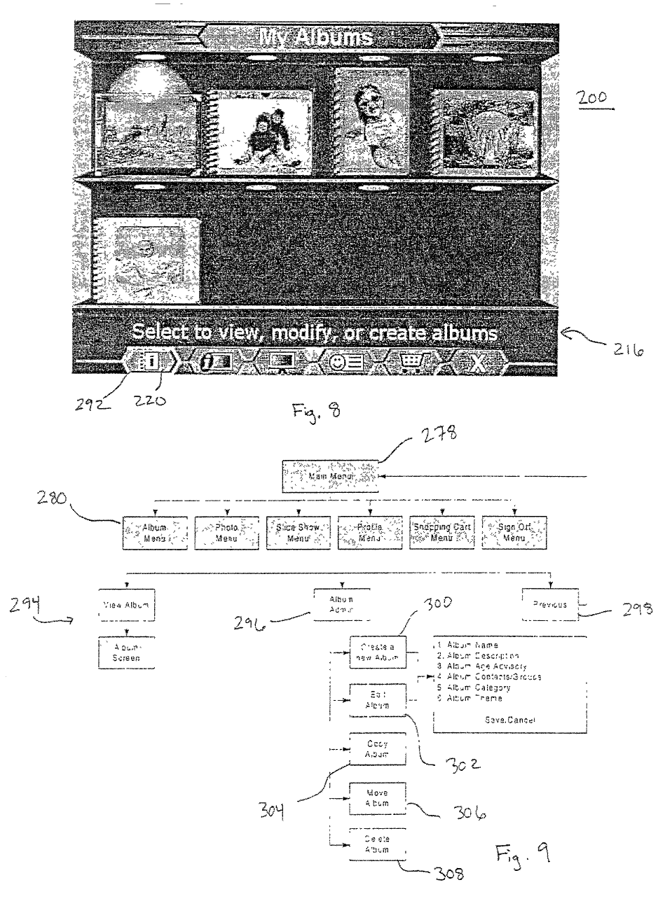

Referring to FIG. 7, a flow diagram depicts a main menu 278 corresponding with the main menu bar 218, along with user selectable menus 280-290 corresponding with the menu display icons 220-230, respectively. Referring to FIG. 8, the user interface screen 200 of FIG. 2 is shown, but with the album menu option 220 highlighted (note illuminated icon outline 292), and the text region 216 including information about operations available upon selection of the album menu option. User selection of the album menu option 220 then provides the user with a set of operations associated with the album menu 280.

FIG. 9 is a flow diagram depicting the set of operations made available to the user upon selection of the album menu 280. Those skilled in the art will understand that these operations may be presented to the user as a selectable toolbar (not shown) like the main menu toolbar 218 described above in connection with FIG. 8. The operations include viewing album operations 294, album administrative operations 296, and exit operations 298 that return the user to the main menu 278. User selection of the album administrative operations 296 will then provide the user with operations for creating a new album 300, editing an album 302, copying an album 304, moving an album 306, and deleting an album 308. These album administrative operations may likewise be presented to the user as a selectable toolbar (not shown).

Selection of either the album creating or editing operations 300 or 302 then provides the user with the ability to enter textual information (such as the album name or description), to identify an album category or theme, and to designate age advisory levels and shared viewing options with designated contacts or groups of other users.

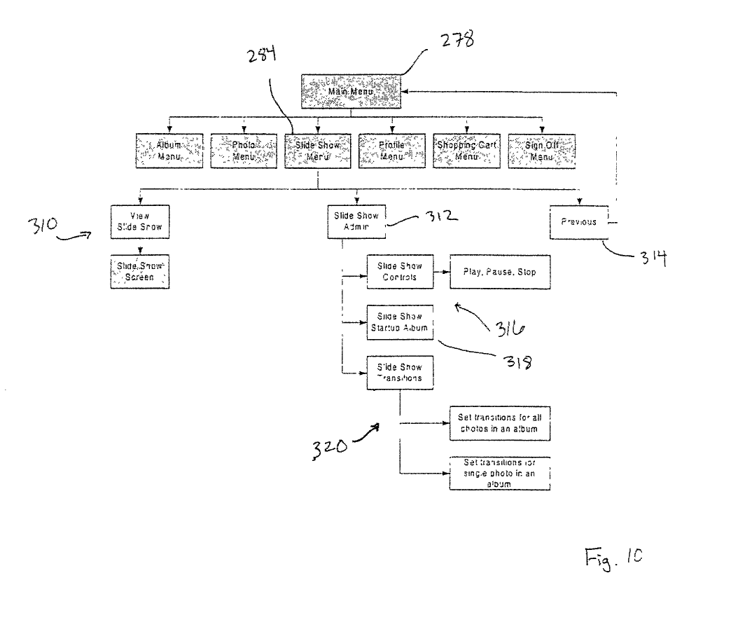

FIG. 10 is a flow diagram depicting the set of operations made available to the user upon selection of the slide show menu 284. Those skilled in the art will understand that these operations may be presented to the user as a selectable toolbar (not shown) like the main menu toolbar 218 described above in connection with FIG. 8. The operations include viewing slide show operations 310, slide show administrative operations 312, and exit operations 314 that return the user to the main menu 278. User selection of the slide show administrative operations 312 will then provide the user with slide show control operations 316 (such as play, pause, and stop operations), slide show startup operations 318, and slide show transition operations 320, in which the user can set the types of transitions (such as visual or sound effects) between photographs displayed in a slide show. These slide show administrative operations may likewise be presented to the user as a selectable toolbar (not shown).

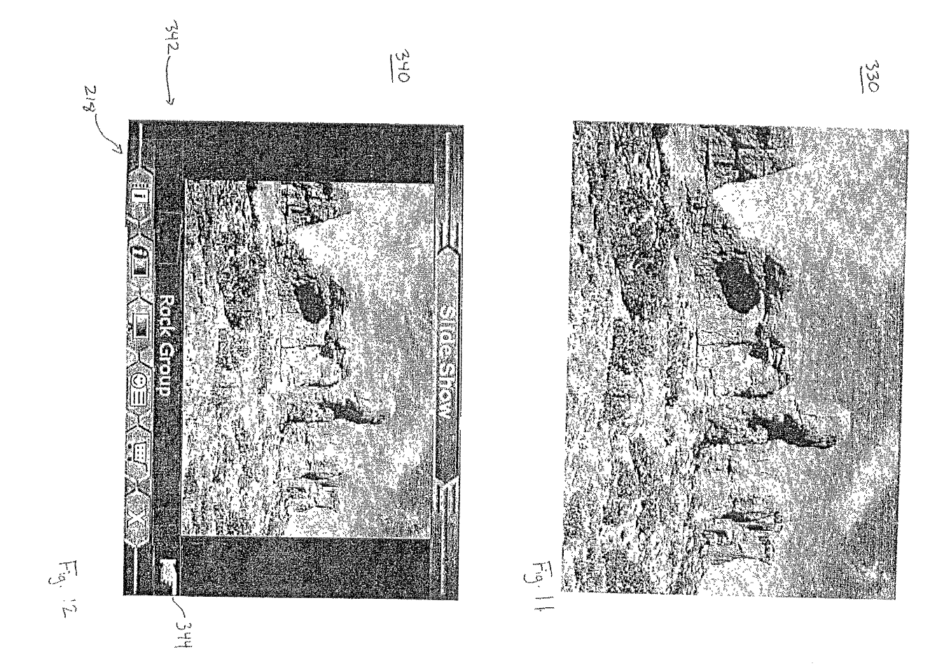

FIG. 11 shows one type of slide show presentation screen 330, in which each photograph occupies the full screen, and the slide show may transition between photographs at time intervals previously set by the user or by user action with cursor control buttons. FIG. 12 shows a second type of slide show presentation screen 340, including a text region 342 containing a title given by the user to the displayed photograph, along with a directional indicator 344 informing the user that additional photographs are available for viewing. The slide show presentation screen 340 may also transition between photographs at set time intervals or in response to user action with cursor control buttons. The slide show presentation screen 340 also includes the main menu bar 218, from which the user can highlight and select different menu options by use of the cursor control and SELECT buttons as described above. Each of the photo albums 202-210 shown in FIG. 2 can be displayed as a slide show, by the user first highlighting the desired photo album and then selecting the slide show menu icon 224 in the main menu toolbar 218.

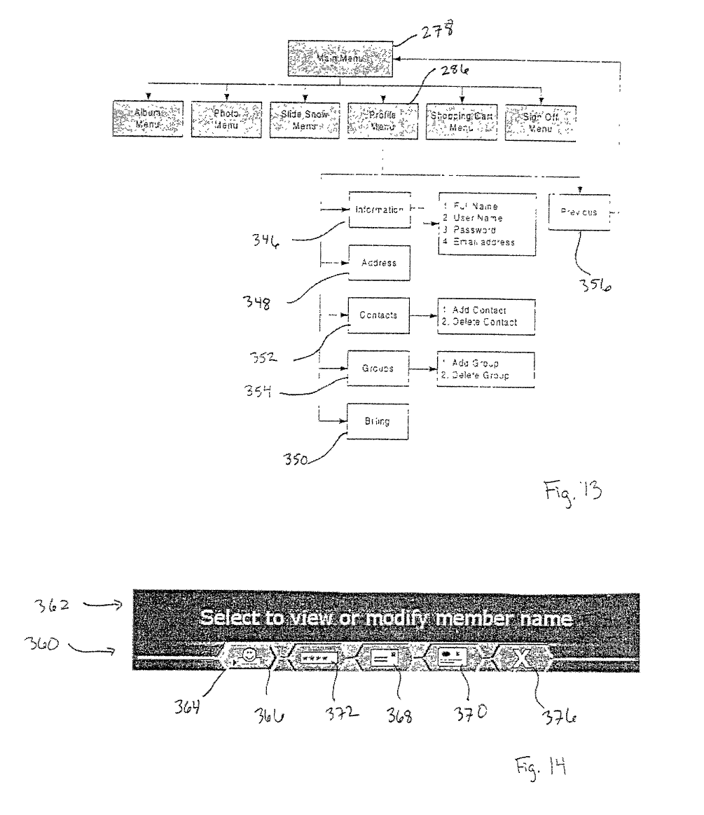

FIG. 13 is a flow diagram depicting the set of operations made available to the user upon selection of the user profile menu 286. The operations include user information operations 346, in which the user can set name, e-mail address, and password information. Address and billing operations 348 and 350, respectively, are provided for the user to set mailing address and billing information. Contacts and group operations 352 and 354, respectively, are provided for the user to add or delete contacts or groups including other users. Finally, exit operations 356 are provided for returning the user to the main menu 278.

FIG. 14 shows a profile toolbar 360 that is presented to the user upon selection of the profile menu icon 226 from the main menu toolbar 218 (see FIG. 2). Also included is a text region 362 that includes information about operations available upon selection of the currently highlighted icon (note illuminated icon outline 364). The profile toolbar 360 has five operations options icons, the user selection of which initiate corresponding operations described above in connection with FIG. 13—namely, a user information icon 366, address and billing icons 368 and 370, respectively, contacts and groups icon 372, and an exit icon 376.

As described above in a number of instances, the user is provided the opportunity to input textual information, whether descriptions of individual photographs and albums, or text for photo storybooks, or user profile information, etc. In the case of the user of a personal computer, such textual information is readily input via the computer keyboard. However, the set-top box equipped television user typically has only conventional television controls lacking text input keys.

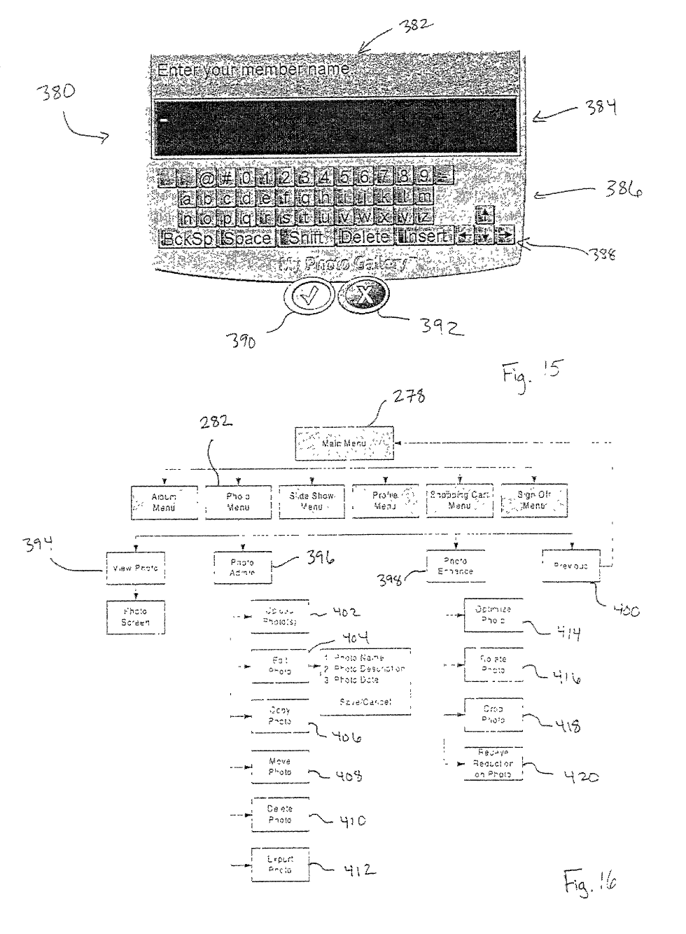

FIG. 15 depicts a keyboard-text display 380 that is provided to the user when text entry is required (or desired). The keyboard-text display 380 includes a category region 382 identifying the type of textual information to be input. In the example shown, the user is prompted for a name, such as when providing textual information during user information operations 346 in the user profile menu 286 (see FIG. 13). The keyboard-text display 380 includes a text region 384 in which the entered text is displayed. A keyboard region 386 is provided for the user to input text characters, with the user highlighting and selecting individual keys within the keyboard region by use of the television remote cursor control (e.g., left and right) and SELECT buttons. Movement of the text entry point within the text region 384 is itself controlled by cursor control keys 388 provided as part of the keyboard region 386. Finally the user can decide to save or cancel the full text entered in the text region 384 by selecting save or cancel buttons 390 or 392, respectively, with movement between these buttons and the keyboard region 386 being accomplished by use of the television remote cursor control (e.g., up and down).

FIG. 16 is a flow diagram depicting the set of operations made available to the user upon selection of the photo menu 282. Those skilled in the art will understand that these operations may be presented to the user as a selectable toolbar (not shown) like the main menu toolbar 218 described above in connection with FIG. 8. The operations include viewing photo operations 394, photo administrative operations 396, photo enhancement operations 398, and exit operations 400 that return the user to the main menu 278. User selection of the photo administrative operations 396 will then provide the user with operations to import or upload photos 402, edit photos 404 (in which descriptive textual information can be entered by the user), copy photos 406, move photos 408, delete photos 410, and export photos 412. User selection of the photo enhancement operations 398 provides the user with operations to optimize photos 414, rotate photos 416, crop photos 418, and reduce redeye 420. The photo administrative and enhancement operations may likewise be presented to the user as selectable toolbars (not shown).

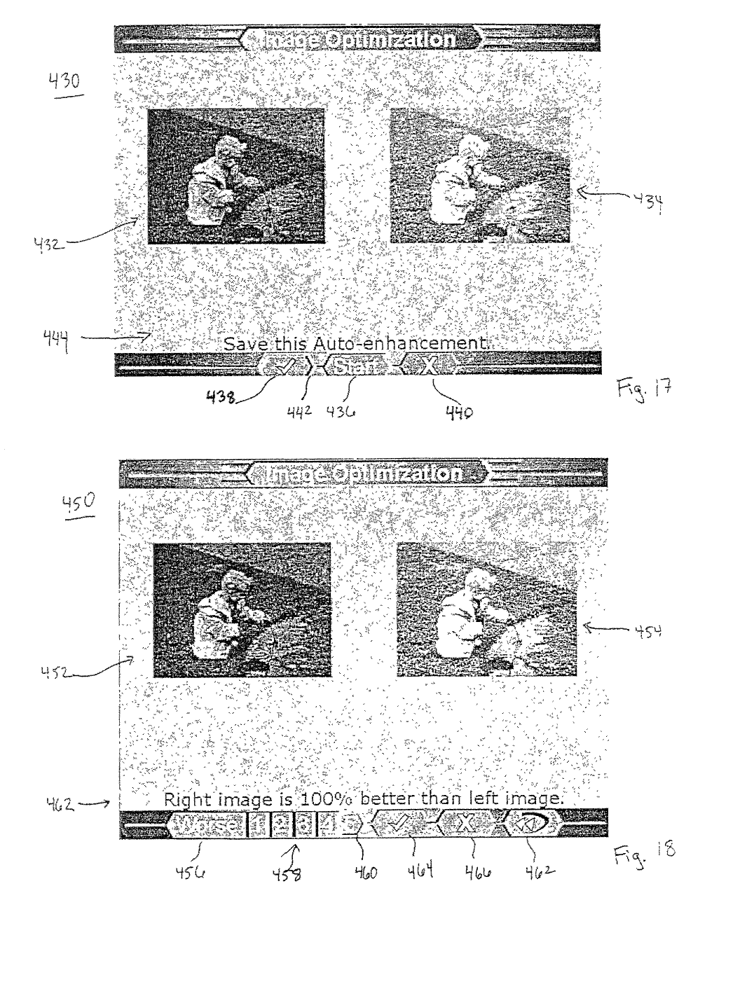

FIG. 17 shows one type of photo optimization display 430, in which the user is presented with a photograph 432 and an enhanced version 434 for comparison. The enhancement process is performed automatically, with the user choosing whether to save or cancel the resulting enhanced image, via a save button 438 or cancel button 440. In the example shown, the save button 438 is currently highlighted (note illuminated icon outline 442) and a text region 444 includes a description of the operations associated with selection of the save button. A second type of photo optimization (described below) is made available to the user in response to user selection of a start button 436.

FIG. 18 shows a second type of photo optimization display 450, in which the user is presented with a photograph 452 and an enhanced version 454 for comparison. In this case, the user can quantitatively rate the comparison of the two images by selection of a Worse button 456 or one of a plurality of quantitatively better buttons 458 that indicate the degree to which the user believes the enhanced photograph to be better. In the example shown, one of the quantitatively better buttons 458 is highlighted (note illuminated icon outline 460) and a text region 462 includes a description of the quantitative judgment made by the user upon selection of the highlighted button. The user can undo an optimization operation via an undo button 462, and can determine whether to save or cancel an enhanced image via a save button 464 and a cancel button 466.

Photographic enhancement operations can be accomplished according to the methods and systems described in International Patent Application No. PCT/US99/28676, the disclosure of which is incorporated herein by reference.

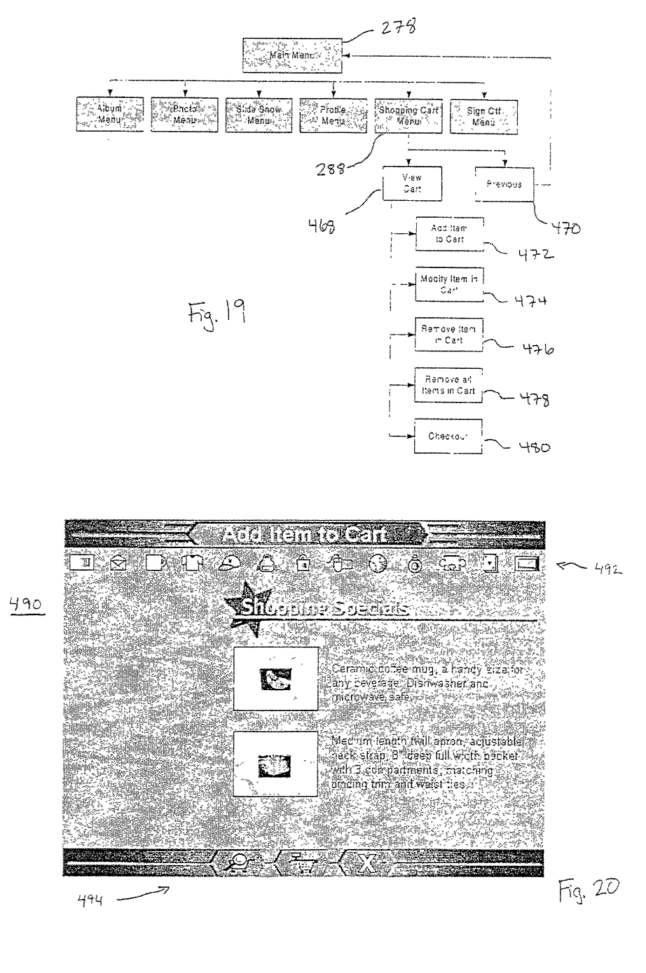

FIG. 19 is a flow diagram depicting the set of operations made available to the user upon selection of the shopping cart menu 288. Those skilled in the art will understand that these operations may be presented to the user as a selectable toolbar (not shown) like the main menu toolbar 218 described above in connection with FIG. 8. The operations include view cart operations 468 and exit operations 470 that return the user to the main menu 278. User selection of the view cart operations 468 will then provide the user with operations to add an item to the cart 472, modify an item in the cart 474, remove an item in the cart 476, remove all items from the cart 478, and checkout operations 480.

FIG. 20 depicts a product promotion screen 490 that can be presented to a user upon user selection of the add item to cart operations 472. In this display, particular products (in this example, a cup and an apron) are promoted. The display 490 includes product icons 492 which the user can select for consideration of a variety of products for potential purchase. The display 490 also includes operations icons 494 associated with the shopping cart menu 288, such as view cart operations 468, checkout operations 480, and exit operations 470.

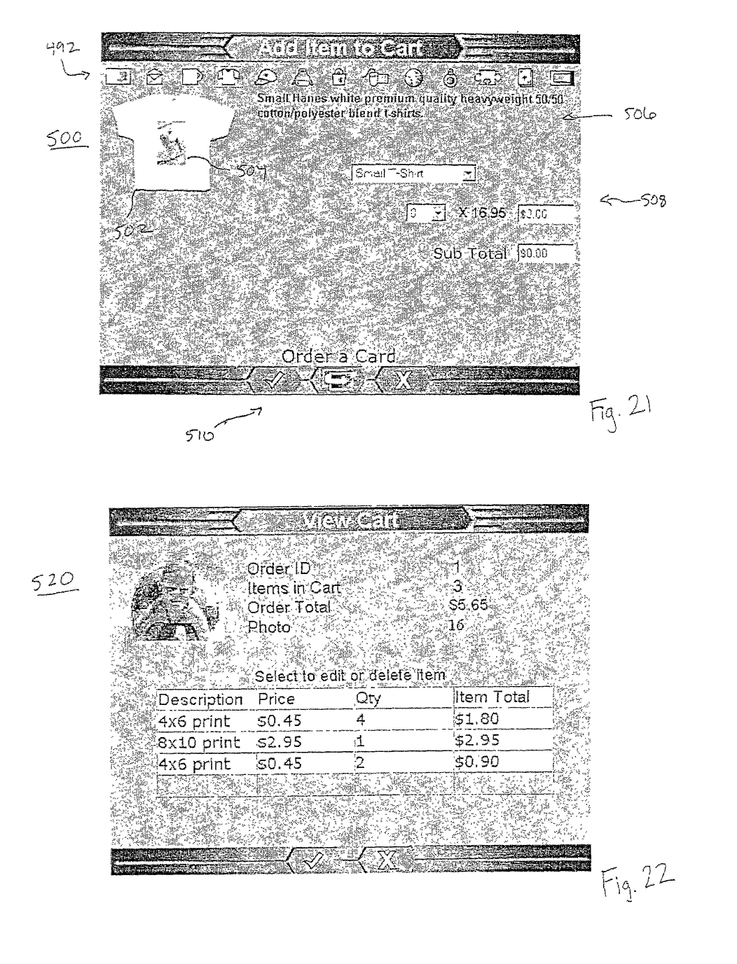

FIG. 21 depicts a product display screen 500, in which a particular product is displayed corresponding to a highlighted one of the product icons 492—namely, a shirt 502 including a photographic image 504. The user determines which photograph will be displayed on a product by first highlighting the desired photograph and then selecting the shopping cart menu icon 228 from the main menu toolbar 218 (see FIGS. 2-6). The product icons 492 may vary depending on product offerings by vendors in the user's geographical area or other vendor criteria. The presented product icons 492 may depend, therefore, on user profile information and corresponding product availability.

Importantly, the product display screen 500 includes a depiction of how the actual product will look with the selected photographic image, for more realistic and improved promotion of such products to the user. The product display screen 500 also includes a text region 506 having a description of the product, and an order information region 508 for indicating the type and quantity of the product ordered. Operations icons 510 are also provided for the user to save or cancel an order, or for promoting other product purchases, such as the depicted highlighted icon and associated text prompting the user to also order a card bearing the photographic image 504. Such a card could then be sent electronically to user-designated recipients, such as via e-mail, along with text entered by the user. Finally, FIG. 22 depicts a cart contents display 520, in which product types, quantity, and purchase information is provided to the user.

While certain embodiments of the present invention have been illustrated and described, it will be appreciated that various changes can be made without departing from the spirit and scope of the invention. Other familiar representations of photographic images can be employed, such as pictorial calendar displays. The particular embodiments described above relate to digital images, while those skilled in the art will appreciate the invention's applicability to other digital media as well. For example, collections of digital music media could be depicted as albums or compact discs in a jukebox, or a radio tuner with selectable areas for music genre, artist index, and album or song index. As a further example, the digital media could be streaming video content, with graphical representations of video-tape boxes or film stills used as selectable representations of the streaming video content. Accordingly, the invention is not limited except as by the appended claims.

The embodiments of the invention in which an exclusive property or privilege is claimed are defined as follows:

1. A user interface for receiving user instructions from an input device, and for presenting digital media to a user and allowing user manipulation of that media, the interface comprising:
a plurality of digital media items configurable by the user;
a plurality of graphical representations presented to the user, each of the graphical representations being associated with a respective one of the digital media items and depicting one of a plurality of a user-familiar environments, and each of the graphical representations being selectable by the user;
a menu having a plurality of menu options selectable by the user; and
wherein the user can configure the digital media items and select the graphical representations and the menu options with up, down, left, right, and selection instructions.

2. The interface of claim 1 wherein each of the digital media items is a digital image, and wherein each of the graphical representations depicts a photograph displayed in an open photo album.

3. The interface of claim 1 wherein each of the digital media items is a digital image, and wherein each of the graphical representations depicts a framed picture displayed in a gallery.

4. The interface of claim 1 wherein each of the digital media items is a digital image, and wherein each of the graphical representations depicts a photograph included in a filmstrip.

5. The interface of claim 1 wherein each of the digital media items is a digital image, and wherein each of the graphical representations depicts a photograph and associated text in a storybook.

6. The interface of claim 1 wherein each of the digital media items is a digital image, and wherein each of the graphical representations depicts a photographic slide in a slide show.

7. The interface of claim 1, further comprising a plurality of text entries input by the user and associated with respective ones of the digital media items.

8. The interface of claim 7, further comprising a keyboard display presented to the user and operable by the user with the up, down, left, right, and selection instructions for user input of the text entries.

9. The interface of claim 1 wherein each of the digital media items is a collection of digital media.

10. The interface of claim 9 wherein each of the digital media items is a collection of digital images, and wherein each of the graphical representations depicts a photo album positioned on a bookcase.

11. The interface of claim 9 wherein each of the digital media items is a collection of digital images, and wherein user selection of each of the graphical representations associated with the digital media items displays the corresponding collection of digital images in one of a plurality of user-determinable formats.

12. The interface of claim 11 wherein the user-determinable formats include depictions of the collections of digital images as photographs displayed in an open photo album.

13. The interface of claim 11 wherein the user-determinable formats include depictions of the collections of digital images as framed pictures displayed in a gallery.

14. The interface of claim 11 wherein the user-determinable formats include depictions of the collections of digital images as photographs in a filmstrip.

15. The interface of claim 11 wherein the user-determinable formats include depictions of the collections of digital images as photographs displayed in a storybook, with each of the photographs having associated text.

16. The interface of claim 1 wherein the user-determinable formats include depictions of the collections of digital images as photographic slides in a slide show.

17. The interface of claim 9, further comprising a plurality of text entries input by the user and associated with respective ones of the collections of digital media.

18. The interface of claim 1 wherein the menu options include:
digital media import operations;
digital media configuration operations;
user information operations; and
product purchase operations.

19. The interface of claim 18, further comprising a keyboard display presented to the user and operable by the user with the up, down, left, right, and selection instructions for user entry of text in connection with the digital media configuration operations and user information operations.

20. The interface of claim 18 wherein each of the digital media items is a digital image, and wherein the menu options further comprise digital image enhancement operations.

21. The interface of claim 1 wherein each of the digital media items is a digital image, and wherein each of the graphical representations depicts a photographic slide in a slide show, and wherein the menu options include slide show operations selectable by the user to configure slide show transitions.

22. The interface of claim 21 wherein the slide show transitions include user-configurable transition times between successive displays of the photographic slides.

23. The interface of claim 21 wherein the slide show transitions include user-configurable visual or audio effects between successive displays of the photographic slides.

24. The interface of claim 1 wherein each of the digital media items is a digital image, and wherein the menu options include product purchase operations selectable by the user to graphically represent one of the digital images on a selected product.

25. The interface of claim 24 wherein the selected product is an electronic greeting card including a digital image and associated text provided by the user for transmission to one or more user-designated recipients.

26. A method of presenting a plurality of digital media items to a user and for allowing manipulation of those media items by the user, the method comprising:
presenting a plurality of graphical representations to the user, each of the graphical representations being selectable by the user and being associated with a respective one of the digital media items, and each of the graphical representations depicting one of a plurality of user-familiar environments;
presenting a menu to the user, with the menu including a plurality of menu options selectable by the user; and
providing the user with selection control of the graphical representations and the menu options by use of up, down, left, right, and selection instructions.

27. The method of claim 26 wherein each of the digital media items is a digital image, and wherein presenting a plurality of graphical representations to the user includes presenting depictions of photographs in an open photo album.

28. The method of claim 26 wherein each of the digital media items is a digital image, and wherein presenting a plurality of graphical representations to the user includes presenting depictions of framed pictures in a gallery.

29. The method of claim 26 wherein each of the digital media items is a digital image, and wherein presenting a plurality of graphical representations to the user includes presenting depictions of photographs in a filmstrip.

30. The method of claim 26 wherein each of the digital media items is a digital image, and wherein presenting a plurality of graphical representations to the user includes presenting depictions of photographs and associated text in a storybook.

31. The method of claim 26 wherein each of the digital media items is a digital image, and wherein presenting a plurality of graphical representations to the user includes presenting depictions of photographic slides in a slide show.

32. The method of claim 26 wherein the menu options include presenting a graphical representation of a keyboard for user entry of text.

33. The method of claim 32 wherein presenting a graphical representation of a keyboard includes providing the user with selection control of text entry by the keyboard by use of the up, down, left, right, and selection instructions.

34. The method of claim 26 wherein each of the digital media items is a collection of digital images, and wherein presenting a plurality of graphical representations to the user includes presenting depictions of photo albums positioned on a bookcase.

35. The method of claim 26 wherein each of the digital media items is a collection of digital images, and wherein providing the user with selection control of the graphical representations includes providing the user with display selection control by which the collections of digital images are selected for display, and wherein the menu options include providing the user with display configuration control by which the collections of digital images can be identified for display in respective ones of a plurality of formats.

36. The method of claim 35 wherein providing the user with display configuration control includes providing user identification of one or more of the collections of digital images for display as photographs in an open photo album.

37. The method of claim 35 wherein providing the user with display configuration control includes providing user identification of one or more of the collections of digital images for display as framed pictures in a gallery.

38. The method of claim 35 wherein providing the user with display configuration control includes providing user identification of one or more of the collections of digital images for display as photographs in a filmstrip.

39. The method of claim 35 wherein providing the user with display configuration control includes providing user identification of one or more of the collections of digital images for display as photographs and associated text in a storybook.

40. The method of claim 35 wherein providing the user with display configuration control includes providing user identification of one or more of the collections of digital images for display as photographic slides in a slide show

41. The method of claim 35 wherein the menu options include presenting a graphical representation of a keyboard for user entry of text.

42. The method of claim 41 wherein presenting a graphical representation of a keyboard includes providing the user with selection control of text entry by the keyboard by use of the up, down, left, right, and selection instructions.

43. The method of claim 26 wherein presenting a menu to the user includes:
presenting digital media import operations;
presenting digital media configuration operations;
presenting user information operations; and
presenting product purchase operations.

44. The method of claim 43 wherein presenting digital media configuration operations or presenting user information operations includes presenting a graphical representation of a keyboard for user entry of text, including providing the user with selection control of text entry by the keyboard by use of the up, down, left, right, and selection instructions.

45. The method of claim 43 wherein each of the digital media items is a digital image, and wherein presenting a menu to the user further includes presenting digital image enhancement operations.

46. The method of claim 26 wherein each of the digital media items is a digital image, and wherein presenting a plurality of graphical representations to the user includes presenting depictions of photographic slides in a slide show, and wherein presenting a menu to the user includes presenting slide show operations selectable by the user to configure slide show transitions.

47. The method of claim 46 wherein presenting slide show operations includes providing user selection of transition times between successive displays of the photographic slides.

48. The method of claim 46 wherein presenting slide show operations includes providing user selection of visual or audio effects between successive displays of the photographic slides.

49. The method of claim 26 wherein each of the digital media items is a digital image, and wherein presenting a menu to the user includes presenting product purchase operations, including providing a graphical representation of a selected one of the digital images on a selected one of a plurality of products.

50. The method of claim 49 wherein the selected product is an electronic greeting card including the selected digital image and associated text provided by the user for transmission to one or more user-designated recipients.
